(19) United States
(12) Patent Application Publication
(10) Pub. No.: US 2026/0214291 A1
(43) Pub. Date: Jul. 23, 2026

(54) DISPLAY DEVICE AND METHOD FOR OPERATING SAME

(71) Applicant: LG ELECTRONICS INC., Seoul (KR)

(72) Inventor: Hyeseung LEE, Seoul (KR)

(73) Assignee: LG ELECTRONICS INC., Seoul (KR)

(21) Appl. No.: 19/136,496

(22) PCT Filed: Dec. 19, 2022
(86) PCT No.: PCT/KR2022/020669

§ 371 Date: Jun. 6, 2025

(51) Int. Cl. H04N 21/422; H04N 21/4363; H04N 21/485

(52) U.S. Cl. CPC H04N 21/42203; H04N 21/43637; H04N 21/4852

(57) ABSTRACT

A display device of the present disclosure comprises: a communication unit that communicates with a plurality of wireless audio devices; a display unit that displays a voice recognition activation notification of the wireless audio devices; and a processor that controls the communication unit and the display unit, wherein the processor may establish a communication connection with the plurality of wireless audio devices, determine whether each wireless audio device supports voice utterance on the basis of the communication connection status of the wireless audio devices, and generate a voice recognition activation notification for the wireless audio devices capable of supporting voice utterance and display same on the display unit.

### TECHNICAL FIELD

The present disclosure relates to a display device capable of displaying an activation state of a wireless sound device capable of supporting voice utterance among a plurality of wireless sound devices, and a method for operating same.

### BACKGROUND ART

In general, a display device is a device that has the function of receiving, processing, and displaying images that can be viewed by a user. A display device receives a broadcast signal selected by a user from among broadcast signals transmitted from a broadcasting station, separates an image signal from the received signal, and then displays the separated image signal on a display.

In recent years, due to the development of broadcasting technology and network technology, the functions of display devices have become considerably more diverse, and the performance of the devices has also improved accordingly. In other words, display devices have evolved to provide users with not only simply broadcasted content, but also various other content.

For example, the display device can provide not only programs received from broadcasting stations, but also game play, music appreciation, Internet shopping, and customized information using various applications. In order to perform these expanded functions, the display device is basically connected to other devices or networks using various communication protocols, and can provide a ubiquitous computing environment to the user. In other words, the display device has evolved into a smart device that enables connectivity to a network and ubiquitous computing.

Meanwhile, the display device supports audio and voice recognition functions when connected to a wireless sound device capable of supporting voice utterance, and only supports audio recognition functions when connected to a wireless sound device incapable of supporting voice utterance.

However, since the display device cannot distinguish between a wireless sound device capable of both audio and voice recognition and a wireless sound device capable of only audio recognition but not voice recognition when a plurality of wireless sound devices are connected, the user cannot know the activation state of the voice function for the wireless sound device, which causes inconvenience in using the voice function of the wireless sound device.

Therefore, in the future, when connected to a plurality of wireless sound devices, it is necessary to develop a display device that can distinguish wireless sound devices capable of supporting voice utterance and provide information on the activation state of the voice function of the wireless sound device.

### DISCLOSURE

### Technical Problem

An object of the present disclosure is to solve the above-described problems and other problems.

An object of the present disclosure is to provide a display device that can improve user convenience by determining whether each wireless sound device supports voice utterance based on the communication state of the wireless sound device and outputting a voice recognition activation notification for a voice utterance-supported wireless sound device, thereby allowing the user to intuitively and easily identify a voice utterance-supported wireless sound device, and a method for operating the same.

### Technical Solution

According to an embodiment of the present disclosure, a display device includes a communication part communicating with a plurality of wireless sound devices; a display part displaying a voice recognition activation notification of the wireless sound devices; and, a processor controlling the communication part and the display part, in which the processor may perform a communication with the plurality of wireless sound devices, determine whether each wireless sound device supports voice utterance based on the communication state of the wireless sound devices, and generate a voice recognition activation notification for a wireless sound device capable of supporting voice utterance to display the voice recognition activation notification on the display part.

According to an embodiment of the present disclosure, a method for operating a display device that communicates with a plurality of wireless sound devices may include performing a communication with the plurality of wireless sound devices; determining whether each wireless sound device supports voice utterance based on a communication state of the wireless sound devices; generating a voice recognition activation notification for the wireless sound device capable of supporting voice utterance; and outputting a voice recognition activation notification for the wireless sound device capable of supporting voice utterance.

### Advantageous Effect

According to one embodiment of the present disclosure, a display device determines whether each wireless sound device supports voice utterance based on a communication of the wireless sound device, and outputs a voice recognition activation notification for a wireless sound device capable of supporting voice utterance, thereby improving user convenience so that a user can intuitively and easily identify a voice utterance-supported wireless sound device.

In addition, the present disclosure provides utterance activation information that indicates that the current utterance is being spoken together with a voice recognition activation notification, thereby allowing a user to intuitively recognize a wireless sound device that is uttering.

In addition, the present disclosure provides an utterance guidance message for voice utterance input together with a voice recognition activation notification for a wireless sound device capable of supporting voice utterance, thereby allowing a user to easily recognize a voice utterance input method.

In addition, the present disclosure can provide user convenience for blocking microphone handover function operation between wireless sound devices capable of supporting voice utterance by providing a microphone function lock menu together with a voice recognition activation notification for a voice utterance-supported wireless sound device.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device according to an embodiment of the present disclosure.

FIG. 4 is a view illustrating an example of utilizing a remote control device according to an embodiment of the present disclosure.

FIG. 5 is a perspective view illustrating a wireless sound device according to an embodiment of the present disclosure.

FIG. 6 is a block diagram illustrating a wireless sound device according to an embodiment of the present disclosure.

FIG. 7 is a block diagram illustrating a display device connected to a plurality of wireless sound devices according to one embodiment of the present disclosure.

FIG. 8 is a flowchart for explaining a method for operating a display device according to an embodiment of the present disclosure.

FIG. 9 is a view for explaining a process of displaying a voice recognition activation notification for a wireless sound device of a display device according to an embodiment of the present disclosure.

FIGS. 10 to 12 are views for explaining a communication list window for a wireless sound device displayed on a display device according to one embodiment of the present disclosure.

FIGS. 13 to 15 are views for explaining a process of displaying voice recognition activation notifications for a plurality of wireless sound devices of a display device according to one embodiment of the present disclosure.

FIG. 16 is a view for explaining a process of displaying utterance activation information of a display device according to one embodiment of the present disclosure.

FIG. 17 is a view for explaining a process of displaying an utterance guidance message of a display device according to one embodiment of the present disclosure.

FIG. 18 and FIG. 19 are views for explaining a process of displaying a switching guide message between wireless sound devices of a display device according to one embodiment of the present disclosure.

FIG. 20 is a view for explaining a process of displaying a microphone function lock menu of a wireless sound device of a display device according to an embodiment of the present disclosure.

FIG. 21 is a view for explaining a process of displaying voice utterance content of a display device according to one embodiment of the present disclosure.

FIG. 22 is a view for explaining a process of displaying a communication list window for a voice utterance-unsupported wireless sound device and a voice utterance-supported wireless sound device in a display device according to an embodiment of the present disclosure.

FIG. 23 is a view for explaining a process of displaying a voice recognition activation notification corresponding to the position coordinates of a wireless sound device of a display device according to an embodiment of the present disclosure.

### BEST MODE

Hereinafter, embodiments disclosed in this specification is described with reference to the accompanying drawings, and the same or corresponding components are given with the same drawing number regardless of reference number, and their duplicated description will be omitted. The suffixes “module” and “part” for components used in the description below are assigned or mixed in consideration of easiness in writing the specification and do not have distinctive meanings or roles by themselves. Moreover, detailed descriptions related to well-known functions or configurations will be ruled out in order not to unnecessarily obscure subject matters of the present disclosure. However, this does not limit the present disclosure within specific embodiments and it should be understood that the present disclosure covers all the modifications, equivalents, and replacements within the idea and technical scope of the present disclosure.

It will be understood that although the ordinal numbers such as first and second are used herein to describe various elements, these elements should not be limited by these numbers. The terms are only used to distinguish one component from other components.

It will also be understood that when an element is referred to as being “connected to” or “engaged with” another element, it can be directly connected to the other element, or intervening elements can also be present. It will also be understood that when an element is referred to as being ‘directly connected to’ another element, there is no intervening elements.

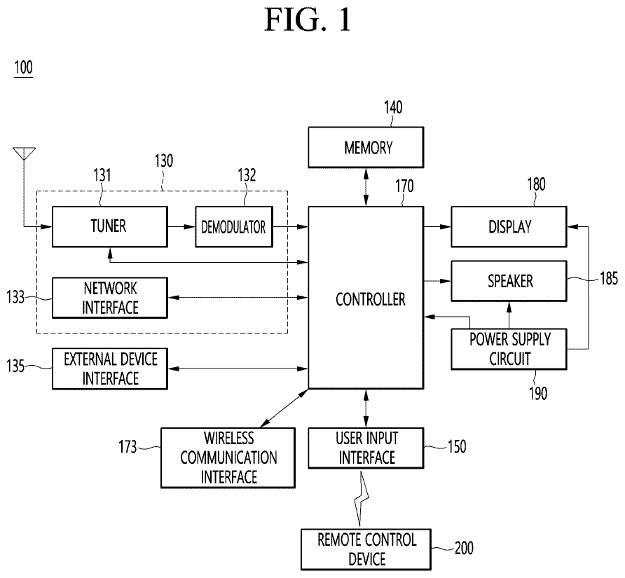

FIG. 1 is a block diagram illustrating a configuration of a display device according to an embodiment of the present disclosure.

Referring to FIG. 1, a display device 100 may include a broadcast reception module 130, an external device interface unit 135, a storage unit 140, a user input part 150, a control unit 170, a wireless communication interface unit 173, a display part 180, a sound output part 185, and a power supply unit 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program-related data signals, and may restore the divided video signals, audio signals, and data signals into an output available form.

The network interface 133 may provide an interface for connecting the display device 100 to a wired/wireless network comprising internet network. The network interface 133 may transmit or receive data to or from another user or another electronic device through an accessed network or another network linked to the accessed network.

The network interface unit 133 may access a predetermined webpage through an accessed network or another network linked to the accessed network. In other words, the network interface unit 133 may transmit or receive data to or from a corresponding server by accessing a predetermined webpage through the network.

The network interface unit 133 may receive content or data provided from a content provider or a network operator. In other words, the network interface unit 133 may receive content, such as movies, advertisements, games, VODs, and broadcast signals, which are provided from the content provider or the network operator, and information relating thereto through the network.

In addition, the network interface unit 133 may receive firmware update information and update files provided from the network operator, and may transmit data to the Internet or content provider or the network operator.

The network interface 133 may select and receive a desired application among applications open to the air, through network.

The external device interface unit 135 may receive an application or an application list in an adjacent external device and deliver the application or the application list to the control unit 170 or the storage unit 140.

The external device interface unit 135 may provide a connection path between the display device 100 and an external device. The external device interface unit 135 may receive at least one of an image or audio outputted from an external device that is wirelessly or wiredly connected to the display device 100 and deliver the received image or the audio to the controller. The external device interface unit 135 may include a plurality of external input terminals. The plurality of external input terminals may include an RGB terminal, at least one High Definition Multimedia Interface (HDMI) terminal, and a component terminal.

An image signal of an external device inputted through the external device interface unit 135 may be outputted through the display part 180. A sound signal of an external device inputted through the external device interface unit 135 may be outputted through the sound output part 185.

An external device connectable to the external device interface unit 135 may be one of a set-top box, a Blu-ray player, a DVD player, a game console, a sound bar, a smartphone, a PC, a USB Memory, and a home theater system but this is just exemplary.

Additionally, some content data stored in the display device 100 may be transmitted to a user or an electronic device, which is selected from other users or other electronic devices pre-registered in the display device 100.

The storage unit 140 may store signal-processed image, voice, or data signals stored by a program in order for each signal processing and control in the control unit 170.

In addition, the storage unit 140 may perform a function for temporarily storing image, voice, or data signals output from the external device interface unit 135 or the network interface unit 133, and may store information on a predetermined image through a channel memory function.

The storage unit 140 may store an application or an application list input from the external device interface unit 135 or the network interface unit 133.

The display device 100 may play content files (for example, video files, still image files, music files, document files, application files, etc.) stored in the storage unit 140, and may provide the content files to a user.

The user input part 150 may transmit signals input by a user to the control unit 170, or may transmit signals from the control unit 170 to a user. For example, the user input part 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR communication methods.

In addition, the user input part 150 may transmit, to the control unit 170, control signals input from local keys (not illustrated) such as a power key, a channel key, a volume key, and a setting key.

Image signals that are image-processed by the control unit 170 may be input to the display part 180 and displayed as images corresponding to the image signals. In addition, image signals that are image-processed by the control unit 170 may be input to an external output device through the external device interface unit 135.

Voice signals processed by the control unit 170 may be output to the sound output part 185. In addition, voice signals processed by the control unit 170 may be input to the external output device through the external device interface unit 135.

Additionally, the control unit 170 may control overall operations of the display device 100.

In addition, the control unit 170 may control the display device 100 by a user command or an internal program input through the user input part 150, and may access the network to download a desired application or application list into the display device 100.

The control unit 170 may output channel information selected by a user together with the processed image or voice signals through the display part 180 or the sound output part 185.

In addition, the control unit 170 may output image signals or voice signals of an external device such as a camera or a camcorder, which are input through the external device interface unit 135, through the display part 180 or the sound output part 185, according to an external device image playback command received through the user input part 150.

Moreover, the control unit 170 may control the display part 180 to display images, and may control the display part 180 to display broadcast images input through the tuner 131, external input images input through the external device interface unit 135, images input through the network interface unit, or images stored in the storage unit 140. In this case, an image displayed on the display part 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

Moreover, the wireless communication part 173 may perform wired or wireless communication with an external device. The wireless communication part 173 may perform short-range communication with an external device. For this, the wireless communication part 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication part 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication part 173 may detect (or recognize) a wearable device capable of communication around the display device 100. Furthermore, if the detected wearable device is a device authenticated to communicate with the display device 100, the control unit 170 may transmit at least part of data processed in the display device 100 to the wearable device through the wireless communication part 173. Therefore, a user of the wearable device may use the data processed by the display device 100 through the wearable device.

The voice acquisition unit 175 may obtain audio. The voice acquisition unit 175 may include at least one microphone (not illustrated) and may obtain audio around the display device 100 through the microphone (not illustrated).

The display part 180 may convert image signals, data signals, or on-screen display (OSD) signals, which are processed in the control unit 170, or images signals or data signals, which are received in the external device interface unit 135, into R, G, and B signals to generate driving signals.

Furthermore, the display device 100 illustrated in FIG. 1 is just one embodiment of the present disclosure and thus, some of the components illustrated may be integrated, added, or omitted according to the specification of the actually implemented display device 100.

In other words, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display part 180 and the sound output part 185.

The sound output part 185 receives the audio-processed signal from the control unit 170 to output an audio signal.

The power supply unit 190 supplies the corresponding power to the entire display device 100. Particularly, power may be supplied to the control unit 170 that is capable of being implemented in the form of a system on chip (SOC), the display part 180 for displaying an image, the sound output part 185 for outputting audio, and the like.

Specifically, the power supply unit 190 may include a converter that converts AC power to DC power and a DC/DC converter that converts a level of the DC power.

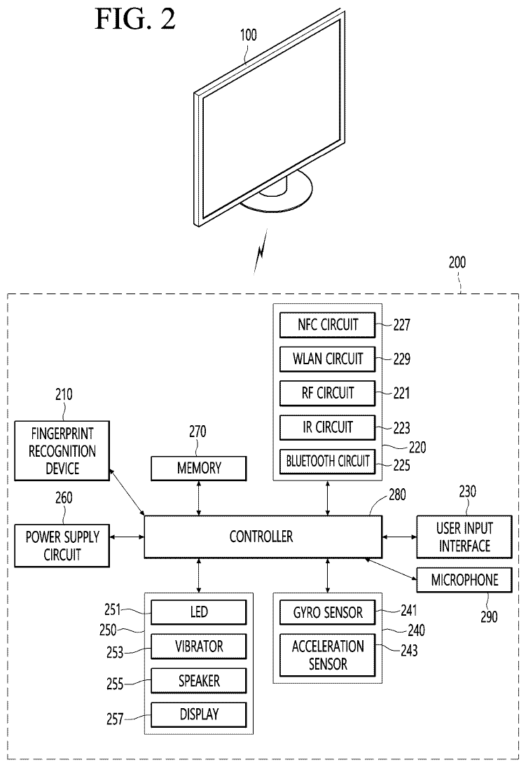

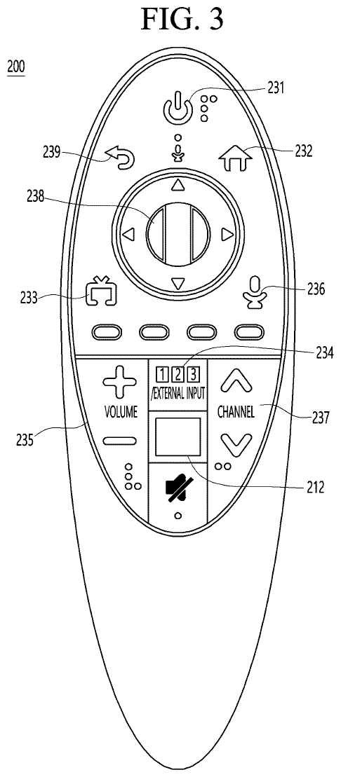

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition unit 210, a wireless communication part 220, a user input part 230, a sensor unit 240, an output part 250, a power supply unit 260, a storage unit 270, a control unit 280, and a sound acquisition unit 290.

Referring to FIG. 2, the wireless communication part 220 transmits/receives signals to/from an arbitrary any one of display devices according to the above-described embodiments of the present disclosure.

The remote control device 200 may include a radio frequency (RF) module 221 capable of transmitting or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication part 220.

Moreover, the remote control device 200 may receive signals transmitted from the display device 100 through the RF module 221 and if necessary, may transmit a command for power on/off, channel change, and volume change to the display device 100 through the IR module 223.

The user input part 230 may be configured with a keypad, a button, a touch pad, or a touch screen. A user may operate the user input part 230 to input a command relating to the display device 100 to the remote control device 200. If the user input part 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation. The power button 231 may be a button for turning on/off the power of the display device 100. The home button 232 may be a button for moving to the home screen of the display device 100. The live button 233 may be a button for displaying live broadcast programs. The external input button 234 may be a button for receiving an external input connected to the display device 100. The volume control button 235 may be a button for controlling a volume output from the display device 100. The voice recognition button 236 may be a button for receiving user's voice and recognizing the received voice. The channel change button 237 may be a button for receiving broadcast signals of a specific broadcast channel. The OK button 238 may be a button for selecting a specific function, and the back button 239 may be a button for returning to a previous screen.

FIG. 2 is described again.

If the user input part 230 includes a touch screen, a user may touch a soft key of the touch screen to input a command relating to the display device 100 to the remote control device 200. In addition, the user input part 230 may include various kinds of input interfaces operable by a user, for example, a scroll key and a jog key, and this embodiment does not limit the scope of the present disclosure.

The sensor unit 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display part 180 of the display device 100.

The output part 250 may output image or voice signals in response to the operation of the user input part 230, or may output image or voice signals corresponding to signals transmitted from the display device 100. A user may recognize whether the user input part 230 is operated or the display device 100 is controlled through the output part 250.

For example, the output part 250 may include an LED module 251 for flashing, a vibration module 253 for generating vibration, a sound output module 255 for outputting sound, or a display module 257 for outputting an image, if the user input part 230 is manipulated or signals are transmitted/received to/from the display device 100 through the wireless communication part 220.

Additionally, the power supply unit 260 supplies power to the remote control device 200 and if the remote control device 200 does not move for a predetermined time, stops the power supply, so that power waste may be reduced. The power supply unit 260 may resume the supply of power if a predetermined key provided at the remote control device 200 is operated.

The storage unit 270 may store various kinds of programs and application data required to control or operate the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to the control of the remote control device 200. The control unit 280 may transmit a signal corresponding to a predetermined key operation of the user input part 230 or a signal corresponding to the movement of the remote control device 200 sensed by the sensor unit 240 to the display device 100 through the wireless communication part 220.

In addition, the sound acquisition unit 290 of the remote control device 200 may obtain voice.

The sound acquisition unit 290 may include at least one microphone and obtain voice through the microphone.

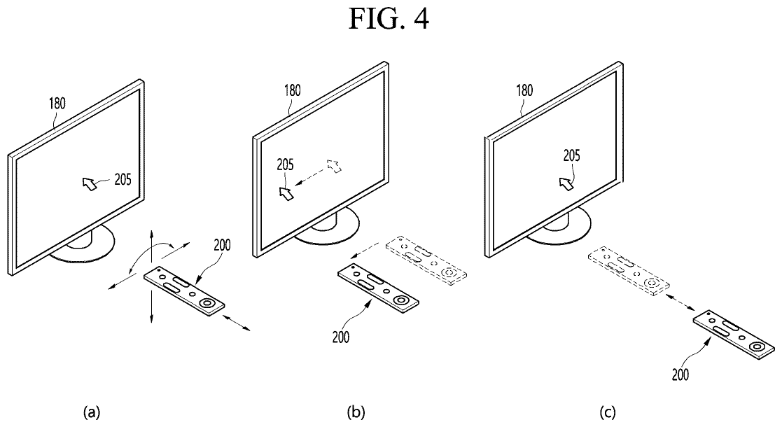

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display part 180.

A user may move or rotate the remote control device 200 vertically or horizontally. The pointer 205 displayed on the display part 180 of the display device 100 corresponds to a movement of the remote control device 200. Since the corresponding pointer 205 is moved and displayed according to a movement on a 3D space as illustrated in the drawing, the remote control device 200 may be referred to as a spatial remote control device.

FIG. 4(b) illustrates that if a user moves the remote control device 200, the pointer 205 displayed on the display part 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display part 180. Thus, a selected region in the display part 180 corresponding to the pointer 205 may be zoomed in and displayed in an enlarged size.

On the other hand, if a user moves the remote control device 200 close to the display part 180, a selection area in the display part 180 corresponding to the pointer 205 may be zoomed out and displayed in a reduced size.

On the other hand, if the remote control device 200 is moved away from the display part 180, a selection area may be zoomed out and if the remote control device 200 is moved closer to the display part 180, a selection area may be zoomed in.

Additionally, if a specific button in the remote control device 200 is pressed, recognition of a vertical or horizontal movement may be excluded. In other words, if the remote control device 200 is moved away from or closer to the display part 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display part 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display part 180 and also may be displayed in correspondence to a plurality of points such as a line and a surface.

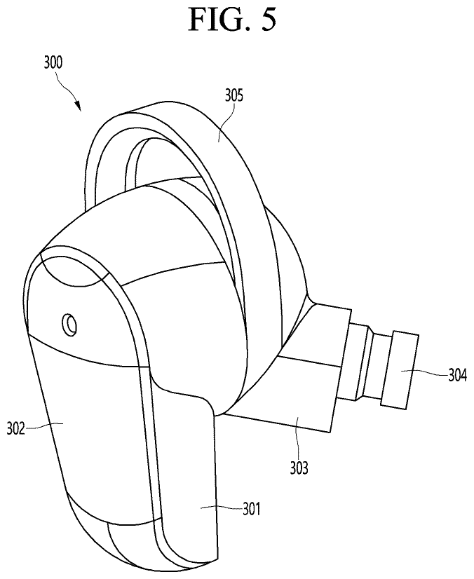

FIG. 5 is a perspective view illustrating a wireless sound device according to an embodiment of the present disclosure.

The wireless earphone of the kernel type as the wireless sound device 300 illustrated in FIG. 5 is only an example, and the present disclosure is not limited thereto. In other words, the wireless sound device 300 in the present disclosure may include headphones, neckband type earphones, kernel type earphones, open type earphones, bone conduction earphones, or the like.

Referring to FIG. 5, the wireless sound device 300 includes a plurality of cases 301, 302, 303, 305, and the cases 301, 302, 303, 305 can be combined to form a housing including an internal space in which electronic components are mounted. A second case 302 coupled to one side of a first case 301 is a part exposed to the outside when a user wears the wireless sound device 300, and a sound output part 340 that outputs sound according to an audio signal is positioned on the other side of the first case 301, and an audio passage 304 that transmits sound to the user can be provided. In order to facilitate mounting of components (for example, sound output part 340, communication part 385) in the first case 301, a part where the audio passage 304 is positioned can be separated to form a separate case 303.

The wireless sound device 300 is a canal-type device that has an audio passage 304 that protrudes in a form that can be inserted into the user's external auditory canal, and an ear tip can be coupled to the outside of the audio passage 304 so as to fit snugly against the user's ear.

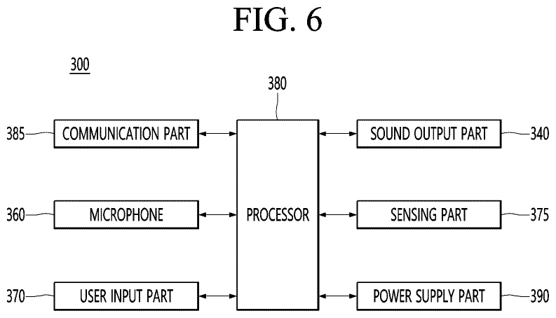

FIG. 6 is a block diagram illustrating a wireless sound device according to an embodiment of the present disclosure.

Referring to FIG. 6, the wireless sound device 300 may include a processor 380, a communication part 385, a sound output part 340, a sensing part 375, a microphone 360, a user input part 370, a power supply part 390, and the like.

The communication part 385 can transmit and receive data with an external device such as a terminal 100 using wireless communication technology, and can include an antenna for transmitting and receiving wireless signals. Since the antenna's radiation performance deteriorates when the antenna comes into contact with the user's body, the antenna can be located in the second case 302 that does not come into contact with the body when worn.

The communication part 385 may be positioned adjacent to the sound output part 340. If the wireless sound device 300 includes a plurality of sound output parts 340, the communication parts 385 may be configured in a number corresponding to each sound output part 340 and may be positioned adjacent to each sound output part 340. For example, if the wireless sound device 300 includes a first sound output part and a second sound output part, the first communication part may be positioned adjacent to the first sound output part and the second communication part may be positioned adjacent to the second sound output part.

The sound output part 340 may include a diaphragm, an sound coil, and a permanent magnet that forms a magnetic field around the sound coil. When power is applied to the sound coil, an electromagnetic force is generated within the magnetic field formed by the permanent magnet, causing the sound coil to move, and the diaphragm may vibrate according to the movement of the sound coil, thereby outputting sound.

The microphone 360 processes the sound signal into electrical voice data. The processed voice data can be transmitted to the terminal 100 or an external server (not illustrated) through the communication part 385. Various noise removal algorithms can be implemented in the microphone 360 to remove noise generated in the process of receiving an external sound signal.

The user input part 370 may refer to an input part or input interface for a user to control the wireless sound device 300. A small wireless sound device 300 may use a touch type or a limited number of buttons, and may expand into inputtable control commands by combining the time and number of times a button is pressed, and a plurality of buttons.

The sensing part 375 can obtain information about the state of the wireless sound device 300 itself and the surrounding situation. The sensing part 375 can include an illumination sensor that detects the brightness of the surroundings, a touch sensor that detects touch input, a gyro sensor or acceleration sensor for detecting the inclination and position of the wireless sound device 300, or the like

The power supply part 390 supplies power required for the processor 380 and each component, and may include a battery. In addition, the power supply part 390 may include a power terminal connected to an external power source to charge the battery. In one embodiment, the power terminal may be in contact with a power terminal formed in a cradle in which the wireless sound device 300 is mounted, and may receive power from an external power source.

The processor 380 can control the overall operation of the wireless sound device 300.

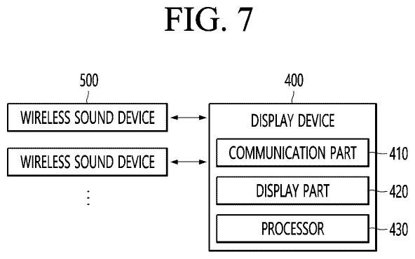

FIG. 7 is a block diagram illustrating a display device connected to a plurality of wireless sound devices according to one embodiment of the present disclosure.

As illustrated in FIG. 7, the display device 400 can communicate with a plurality of wireless sound devices 500 and process voice commands for the plurality of wireless sound devices 500.

The display device 400 may include a communication part 410 that communicates with a plurality of wireless sound devices 500, a display part 420 that displays a voice recognition activation notification of the wireless sound device 500, and a processor 430 that controls the communication part 410 and the display part 420.

Here, the processor 430 can perform communication with a plurality of wireless sound devices 500, determine whether each wireless sound device 500 supports voice utterance based on the communication of the wireless sound device 500, and generates a voice recognition activation notification for a wireless sound device capable of supporting voice utterance to display the voice recognition activation notification on the display part 420.

When performing communication with a plurality of wireless sound devices 500, the processor 430 can perform an audio connection with the wireless sound device 500 through a first communication, and perform a voice connection with the wireless sound device 500 through a second communication.

For example, the processor 430 can perform an audio connection with a wireless sound device through Bluetooth communication, and can perform a voice connection with a wireless sound device through BLE (Bluetooth Low Energy) communication.

In other words, when performing a communication with a plurality of wireless sound devices 500, the processor 430 can search for a wireless sound device 500 through a first communication, perform an audio connection with the wireless sound device searched for through the first communication, search for a wireless sound device 500 through a second communication, check whether the wireless sound device 500 searched for through the second communication is an audio-connected wireless sound device 500, and if it is an audio-connected wireless sound device, perform a voice connection with the audio-connected wireless sound device 500 through the second communication.

Here, the first communication may include Bluetooth communication, and the second communication may include BLE (Bluetooth Low Energy) communication.

In addition, the processor 430, when determining whether the wireless sound device 500 supports voice utterance, may determine the wireless sound device 500 as an voice utterance-unsupported wireless sound device if the communicating wireless sound device 500 has completed only the audio connection through the first communication, and may determine the wireless sound device 500 as a voice utterance-supported wireless sound device if the communicating wireless sound device 500 has completed both the audio connection through the first communication and the voice connection through the second communication.

Here, the first communication may include Bluetooth communication, and the second communication may include BLE (Bluetooth Low Energy) communication.

Next, the processor 430, when generating a voice recognition activation notification, can distinguish between voice utterance-unsupported wireless sound devices and voice utterance-supported wireless sound devices among a plurality of wireless sound devices 500 that communicates with each other based on the determination result of determining whether the wireless sound device 500 supports voice utterance, provide a communication list window that includes voice utterance-unsupported wireless sound device item and voice utterance-supported wireless sound device item, and display a voice recognition activation notification through the communication list window.

Here, the communication list window may include device information for a voice utterance-unsupported wireless sound device item, an audio connection notification that notifies the audio connection state, and device information for a voice utterance-supported wireless sound device item, an audio connection notification that notifies the audio connection state, and a voice recognition activation notification that notifies the voice connection state.

For example, device information for a voice utterance-unsupported wireless sound device item may include the model name of the voice utterance-unsupported wireless sound device, and device information for a voice utterance-supported wireless sound device item may include the model name of the voice utterance-supported wireless sound device, but this is only an example and is not limited thereto.

In addition, the device information for the voice utterance-unsupported wireless sound device item may further include an audio name and an audio address of the voice utterance-unsupported wireless sound device, and the device information for the voice utterance-supported wireless sound device item may further include whether the voice connection communication of the voice utterance-supported wireless sound device is registered, a voice connection communication protocol name, a voice connection communication protocol address, whether voice input is possible, an audio name, an audio address, and whether voice communication is connected, but this is only an example and is not limited thereto.

An audio connection notification may include an audio connection message that indicates an audio connection state, or an audio disconnection message that indicates an audio disconnection state, including an audio connection release or audio connection failure.

Additionally, the voice recognition activation notification may include a voice connection icon indicating a voice connection state, or a voice disconnection icon indicating a voice disconnection state, including a voice connection release or voice connection failure.

Next, when the processor 430 receives the user's voice utterance through a voice utterance-supported wireless sound device, the processor may provide utterance activation information indicating that the current utterance is being spoken to a voice utterance-supported wireless sound device item that provides the user's voice utterance among the voice utterance-supported wireless sound device items included in the communication list window.

As an example, the processor 430 may provide utterance activation information that provides a blinking effect to a voice recognition activation notification corresponding to a voice utterance-supported wireless sound device item that provides the user's voice utterance.

In addition, when there are a plurality of voice utterance-supported wireless sound device items included in the communication list window, the processor 430 can identify a voice utterance-supported wireless sound device item that provides a user's voice utterance based on audio address information of the voice utterance-supported wireless sound device, and provide the utterance activation information to the identified voice utterance-supported wireless sound device item.

Here, when identifying a voice utterance-supported wireless sound device item, the processor 430 compares first audio address information of a voice utterance-supported wireless sound device that provides a user's voice activating with second audio address information of a plurality of voice utterance-supported wireless sound device items included in a communication list window, and if a voice utterance-supported wireless sound device item having second audio address information that is identical to the first audio address information exists among the plurality of voice utterance-supported wireless sound device items included in the communication list window, the processor 430 can identify the corresponding voice utterance-supported wireless sound device item as a voice utterance-supported wireless sound device that provides a user's voice utterance.

Next, when providing a communication list window, if a user input for selecting a voice utterance-supported wireless sound device item is received, the processor 430 can generate and provide an utterance guidance message for voice utterance input to the selected voice utterance-supported wireless sound device item.

For example, when providing an utterance guidance message, the processor 430 may process and provide the utterance guidance message as at least one of text data, voice data, and image data.

In addition, when providing a communication list window, the processor 430 may generate and provide an utterance unavailable guidance message for voice utterance input to the selected voice utterance-unsupported wireless sound device item when a user input for selecting a voice utterance-unsupported wireless sound device item is received.

In addition, when providing a communication list window, the processor 430 may, if receiving a user input for selecting a voice utterance-unsupported wireless sound device item, generate and provide a microphone function deactivation guidance message to a previously selected voice utterance-supported wireless sound device item, and at the same time generate and provide an utterance unavailable guidance message for voice utterance input to a currently selected voice utterance-unsupported wireless sound device item.

In some cases, when providing a communication list window, if a user input for selecting a voice utterance-supported wireless sound device item is received, the processor 430 may generate and provide a microphone function deactivation guidance message to a previously selected voice utterance-supported wireless sound device item, and at the same time, generate and provide a guidance message for notifying the currently selected voice utterance-supported wireless sound device item of the utterance unavailable state and a switching method, and a message for inquiring whether to activate the microphone function.

Here, when receiving a user input requesting activation of a microphone function through a message asking whether to activate the microphone function, the processor 430 can delete a voice recognition activation notification of a previously selected voice utterance-supported wireless sound device item, perform a communication connection with a voice utterance-supported wireless sound device corresponding to the currently selected voice utterance-supported wireless sound device item, and when the voice connection is completed, generate and provide a voice recognition activation notification of the currently selected voice utterance-supported wireless sound device item.

In addition, when displaying a voice recognition activation notification through a communication list window, the processor 430 can create and display a voice recognition activation notification and a microphone function lock menu in a voice utterance-supported wireless sound device item in the communication list window.

Here, the processor 430 can fix the microphone function activation of the corresponding voice utterance-supported wireless sound device item when a user input for activating the microphone function lock menu is received, and block the microphone handover function operation between the voice utterance-supported wireless sound device items.

For example, when a user input for selecting a voice utterance-supported wireless sound device item is received, the processor 430 can check whether a microphone function lock menu of a previously selected voice utterance-supported wireless sound device item is activated, and if the microphone function lock menu of the previously selected voice utterance-supported wireless sound device item is activated, block an operation of handing over a microphone function from a previously selected voice utterance-supported wireless sound device item to a currently selected voice utterance-supported wireless sound device item, thereby maintaining the activation of the microphone function of the previously selected voice utterance-supported wireless sound device item.

Next, the processor 430 may, when receiving a user's voice utterance through a voice utterance-supported wireless sound device, process the user's voice utterance into text and provide the text-processed voice utterance content to a voice utterance-supported wireless sound device item that provides the user's voice utterance among the voice utterance-supported wireless sound device items included in the communication list window.

Here, when there are a plurality of voice utterance-supported wireless sound device items included in the communication list window, the processor 430 can identify a voice utterance-supported wireless sound device item that provides a user's voice utterance based on audio address information of the voice utterance-supported wireless sound device, and provide text-processed voice utterance content to the identified voice utterance-supported wireless sound device item.

For example, when identifying a voice utterance-supported wireless sound device item, the processor 430 can compare first audio address information of a voice utterance-supported wireless sound device that provides a user's voice utterance with second audio address information of a plurality of voice utterance-supported wireless sound device items included in a communication list window, and if a voice utterance-supported wireless sound device item having second audio address information that is identical to the first audio address information exists among the plurality of voice utterance-supported wireless sound device items included in the communication list window, the processor 430 can identify the corresponding voice utterance-supported wireless sound device item as a voice utterance-supported wireless sound device that provides a user's voice utterance.

Next, when providing a communication list window, the processor 430 can identify a voice utterance-supported wireless sound device item that provides the user's voice utterance based on audio address information of the voice utterance-supported wireless sound device when receiving the user's voice utterance through the voice utterance-supported wireless sound device, and provide a communication list window so that the identified voice utterance-supported wireless sound device item is arranged with the highest priority in the communication connection list.

In addition, when generating a voice recognition activation notification, the processor 430 can distinguish between voice utterance-unsupported wireless sound devices and voice utterance-supported wireless sound devices among a plurality of wireless sound devices that communicate to each other based on the determination result of determining whether the wireless sound device 500 supports voice utterance, provides a first communication list window including voice utterance-unsupported wireless sound devices and a second communication list window including voice utterance-supported wireless sound devices, and can display the voice recognition activation notification through the second communication list window.

Here, the first communication list window may include device information for a voice utterance-unsupported wireless sound device, and an audio connection notification that notifies the audio connection state, and the second communication list window may include device information for a voice utterance-supported wireless sound device, an audio connection notification that notifies the audio connection state, and a voice recognition activation notification that notifies the voice connection state.

For example, device information for a voice utterance-unsupported wireless sound device item may include the model name of the voice utterance-unsupported wireless sound device, and device information for a voice utterance-supported wireless sound device item may include the model name of the voice utterance-supported wireless sound device, but this is only an example and is not limited thereto.

In addition, the device information for the voice utterance-unsupported wireless sound device item may further include an audio name and an audio address of the voice utterance-unsupported wireless sound device, and the device information for the voice utterance-supported wireless sound device item may include whether the voice connection communication of the voice utterance-supported wireless sound device is registered, a voice connection communication protocol name, a voice connection communication protocol address, whether voice input is possible, an audio name, an audio address, and whether voice communication is connected, but this is only an example and is not limited thereto.

Here, the audio connection notification may include an audio connection message that indicates an audio connection state, or an audio disconnection message that indicates an audio disconnection state, including an audio connection release or audio connection failure.

Additionally, the voice recognition activation notification may include a voice connection icon indicating a voice connection state, or a voice disconnection icon indicating a voice disconnection state, including a voice connection release or voice connection failure.

Next, the display device 400 of the present disclosure may include a camera that photographs a plurality of wireless sound devices.

Here, the processor 430 can control the generation of a voice recognition activation notification by activating the camera to obtain an image from the camera, calculating the position coordinates of the wireless sound device based on the obtained image, and displaying the voice recognition activation notification on a specific area corresponding to the position coordinates of the wireless sound device among the display screens of the display part 420 when the voice recognition activation notification is generated.

Next, when a voice recognition activation notification for a wireless sound device capable of supporting voice utterance is displayed, the processor 430 can receive a user's voice utterance from the wireless sound device capable of supporting voice utterance and perform a control command corresponding to the user's voice utterance.

Here, when performing a control command, if the first control command of voice utterance received from a first voice utterance-supported wireless sound device among a plurality of wireless sound devices 500 and the second control command of voice utterance received from a second voice utterance-supported wireless sound device conflict with each other, the processor 430 may perform the control command of voice utterance received from a voice utterance-supported wireless sound device with a higher priority based on preset priority information, and ignore the control command of voice utterance received from a voice utterance-supported wireless sound device with a relatively lower priority.

In some cases, when performing a control command, the processor 430 may obtain control command information for each voice utterance-supported wireless sound device and provide user-specific recommendation information based on the control command information for each voice utterance-supported wireless sound device.

In another case, when executing a control command, the processor 430 may obtain control command information for each voice utterance-supported wireless sound device, and predict and provide a display screen configuration for each user based on the control command information for each voice utterance-supported wireless sound device.

The display device of the present disclosure determines whether each wireless sound device supports voice utterance based on the communication of the wireless sound device, and outputs a voice recognition activation notification for a wireless sound device capable of supporting voice utterance, thereby improving user convenience so that the user can intuitively and easily identify a voice utterance-supported wireless sound device.

In addition, in the present disclosure, utterance activation information indicating that the current utterance is being spoken together with a voice recognition activation notification for wireless sound devices capable of supporting voice utterance, thereby allowing a user to intuitively recognize a wireless sound device that is uttered.

In addition, in the present disclosure, utterance guidance message for voice utterance input is provided together with a voice recognition activation notification for a wireless sound device capable of supporting voice utterance, thereby allowing a user to easily recognize a voice utterance input method.

In addition, in the present disclosure, a microphone function lock menu is provided together with a voice recognition activation notification for a wireless sound device capable of supporting voice utterance, thereby providing user convenience for blocking microphone handover function operation between voice utterance-supported wireless sound devices.

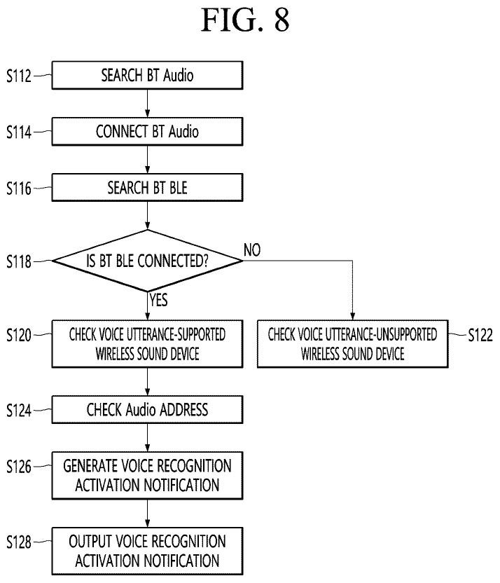

FIG. 8 is a flowchart for explaining a method for operating a display device according to an embodiment of the present disclosure.

As illustrated in FIG. 8, the present disclosure can perform communication with a plurality of wireless sound devices.

The present disclosure can search for a wireless sound device via Bluetooth communication (S112) and perform an audio connection with the wireless sound device searched via Bluetooth (S114).

In addition, in the present disclosure, a wireless sound device through BLE (Bluetooth Low Energy) communication (S116) is searched, and if the wireless sound device searched for through BLE communication is a wireless sound device with audio connection, it can check whether a voice connection is established with the wireless sound device with audio connection through BLE communication (S118).

Next, in the present disclosure, when connected to a wireless sound device with audio connection via BLE communication, the voice-connected wireless sound device can be checked as a voice-activated wireless sound device (S120), a wireless sound device that is not connected to a voice can be identified as a voice utterance-unsupported wireless sound device (S122).

In the present disclosure, it can be determined whether each wireless sound device supports voice utterance based on the communication state of the wireless sound device.

In other words, in the present disclosure, if the wireless sound device has completed only the audio connection through the first communication such as Bluetooth, the wireless sound device is determined as a voice utterance-unsupported wireless sound device, and if both an audio connection has been completed through a first communication such as Bluetooth and a voice connection has been completed through a second communication such as BLE communication, a wireless sound device can be determined as a voice utterance-supported wireless sound device.

Next, in the present disclosure, audio address information of a voice-connected wireless sound device is checked (S124), and recognize a wireless sound device capable of supporting voice utterance based on the audio address information.

Additionally, in the present disclosure, a voice recognition activation notification for a wireless sound device capable of supporting voice utterance can be generated (S126).

Next, in the present disclosure, a voice recognition activation notification for a wireless sound device capable of supporting voice utterance can be output (S128).

Here, in the present disclosure, a voice utterance-unsupported wireless sound devices and a voice utterance-supported wireless sound devices can be distinguished among a plurality of wireless sound devices, a communication list window including the voice utterance-unsupported wireless sound devices and the voice utterance-supported wireless sound devices can be provided, and a voice recognition activation notification can be displayed on a display screen through the communication list window.

For example, a voice recognition activation notification may include a voice connection icon indicating a voice connection state, or a voice disconnection icon indicating a voice disconnection state, including a voice connection release or voice connection failure.

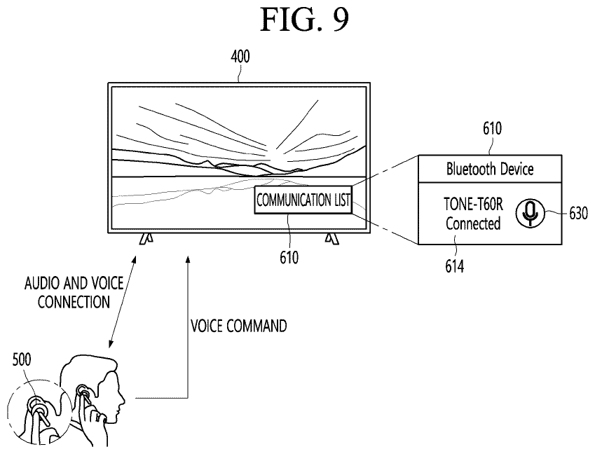

FIG. 9 is a view for explaining a process of displaying a voice recognition activation notification for a wireless sound device of a display device according to an embodiment of the present disclosure.

As illustrated in FIG. 9, the display device 400 of the present disclosure can perform a communication with a wireless sound device 500.

Here, the display device 400 can perform an audio connection with the wireless sound device 500 through the first communication, and can perform a voice connection with the wireless sound device 500 through the second communication.

For example, the display device 400 can perform an audio connection with a wireless sound device through Bluetooth communication, and can perform a voice connection with a wireless sound device through BLE (Bluetooth Low Energy) communication.

Next, the display device 400 can determine whether the wireless sound device 500 supports voice utterance based on the communication state of the wireless sound device 500.

For example, the display device 400 may determine the communicating wireless sound device 500 as a voice utterance-unsupported wireless sound device if only the audio connection is completed through the first communication, and may determine the wireless sound device 500 as a voice utterance-supported wireless sound device if both the audio connection is completed through the first communication and the voice connection is completed through the second communication.

Next, the display device 400 can output a voice recognition activation notification 630 for a wireless sound device 500 capable of supporting voice utterance on the display screen.

Here, the display device 400 can provide a communication list window 610 including a wireless sound device item 614 capable of supporting voice utterance, and can display a voice recognition activation notification 630 through the communication list window 610.

For example, the voice recognition activation notification 630 may include a voice connection icon that indicates a voice connection state, or a voice disconnection icon that indicates a voice disconnection state, including a voice connection release or voice connection failure.

In addition, when a voice recognition activation notification 630 for a wireless sound device 500 capable of supporting voice utterance is displayed, the display device 400 can receive a user's voice command from the wireless sound device 500 capable of supporting voice utterance, and perform a control command corresponding to the user's voice utterance.

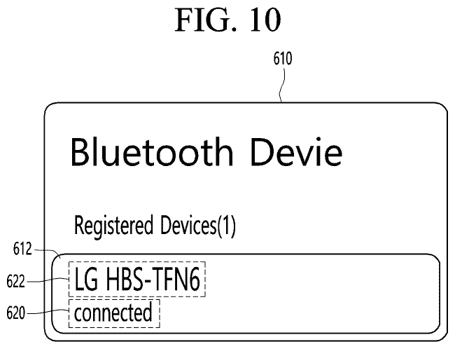

FIGS. 10 to 12 are views for explaining a communication list window for a wireless sound device displayed on a display device according to one embodiment of the present disclosure.

As illustrated in FIGS. 10 to 12, the present disclosure may provide a communication list window 610 for a wireless sound device when a communication is established with the wireless sound device.

In other words, in the present disclosure, a voice utterance-unsupported wireless sound devices and a voice utterance-supported wireless sound devices can be distinguished among a plurality of wireless sound devices, a communication list window 610 including the voice utterance-unsupported wireless sound device items 612 and the voice utterance-supported wireless sound device items 614 can be provided, and a voice recognition activation notification 630 can be displayed through the communication list window.

As illustrated in FIG. 10, the present disclosure may provide a communication list window 610 including the voice utterance-unsupported wireless sound device items 612.

Here, the communication list window 610 of FIG. 10 may include device information 622 for a voice utterance-unsupported wireless sound device items 612, and an audio connection notification 620 that informs of the audio connection state.

For example, device information 622 for a voice utterance-unsupported wireless sound device items 612 may include the model name of the voice utterance-unsupported wireless sound device.

In some cases, device information 622 for a voice utterance-unsupported wireless sound devices 612 may further include an audio name and audio address of the voice utterance-unsupported wireless sound device items 612.

Additionally, the audio connection notification 620 may include an audio connection message that informs of the audio connection state, but this is only an example and is not limited thereto.

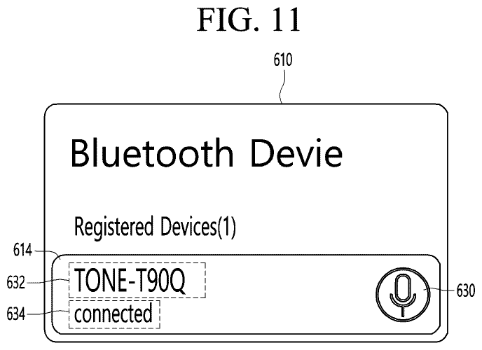

As illustrated in FIG. 11, the present disclosure may provide a communication list window 610 including a voice utterance-supported wireless sound device item 614.

Here, the communication list window 610 of FIG. 11 may include device information 632 for a voice utterance-supported wireless sound device item 614, an audio connection notification 634 that notifies the audio connection state, and a voice recognition activation notification 630 that notifies the voice connection state.

For example, device information 632 for a voice utterance-supported wireless sound device item 614 may include the model name of the voice utterance-supported wireless sound device.

In some cases, device information 632 for a voice utterance-supported wireless sound device item 614 may further include whether the voice utterance-supported wireless sound device is registered for voice connection communication, a voice connection communication protocol name, a voice connection communication protocol address, whether voice input is possible, an audio name, an audio address, and whether voice communication is connected.

Additionally, the audio connection notification 634 may include an audio connection message that indicates the audio connection state, and the voice recognition activation notification 630 may include a voice connection icon that indicates the voice connection state, but this is only an example and is not limited thereto.

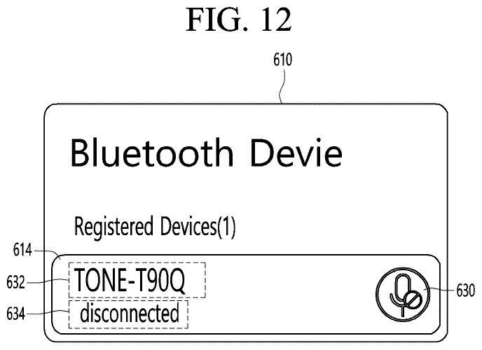

As illustrated in FIG. 12, in the present disclosure, device information 632, an audio connection notification 634, and a voice recognition activation notification 630 for a voice utterance-supported wireless sound device item 614 whose communication is disconnected in a communication list window 610 may be included when the communication connection with the wireless sound device is disconnected.

Here, the audio connection notification 634 may include an audio disconnection message that notifies an audio disconnection state, including an audio connection release or audio connection failure.

Additionally, the voice recognition activation notification 630 may include a voice disconnection icon that indicates a voice disconnection state, including voice connection release or voice connection failure.

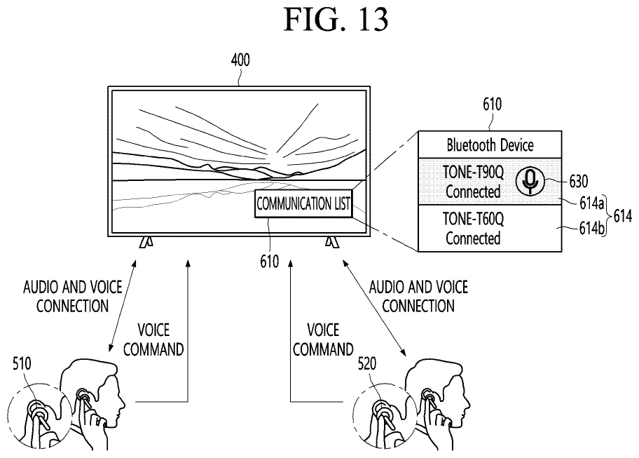

FIGS. 13 to 15 are views for explaining a process of displaying voice recognition activation notifications for a plurality of wireless sound devices of a display device according to one embodiment of the present disclosure.

As illustrated in FIG. 13, the display device 400 of the present disclosure can perform communication with a plurality of wireless sound devices, including a first wireless sound device 510 and a second wireless sound device 520.

Here, the display device 400 can perform an audio connection with the wireless sound device 500 through the first communication, and can perform a voice connection with the wireless sound device 500 through the second communication.

For example, the display device 400 can perform an audio connection with a wireless sound device through Bluetooth communication, and can perform a voice connection with a wireless sound device through BLE (Bluetooth Low Energy) communication.

Next, the display device 400 can determine whether the wireless sound device 500 supports voice utterance based on the communication state of the wireless sound device 500.

For example, the display device 400 may determine the wireless sound device 500 as a voice utterance-unsupported wireless sound device if the communicating wireless sound device 500 has completed only the audio connection through the first communication, and may determine the wireless sound device 500 as the voice utterance-supported wireless sound device if both the audio connection is completed through the first communication and the voice connection is completed through the second communication.

Next, if the display device 400 determines that both the first wireless sound device 510 and the second wireless sound device 520 are wireless sound devices capable of supporting voice recognition, the display device 400 can output a voice recognition activation notification 630 for the first wireless sound device 510 and the second wireless sound device 520 on the display screen.

Here, the display device 400 provides a communication list window 610 including a plurality of voice utterance-supported wireless sound device items 614, and can display a voice recognition activation notification 630 through the communication list window 610.

For example, a voice utterance-supported wireless sound device item 614 may include a first voice utterance-supported wireless sound device item 614a corresponding to a first wireless sound device 510 and a second voice utterance-supported wireless sound device item 614b corresponding to a second wireless sound device 520.

In addition, when a voice recognition activation notification 630 for a wireless sound device capable of voice utterance support is displayed, the display device 400 can receive a user's voice command from wireless sound devices capable of supporting voice utterance and perform a control command corresponding to the user's voice utterance.

In this way, the present disclosure can identify a voice utterance-supported wireless sound device that provides a user's voice utterance based on audio address information of the voice utterance-supported wireless sound device when there are a plurality of wireless sound devices with the same model name among the voice utterance-supported wireless sound device items included in the communication list window 610.

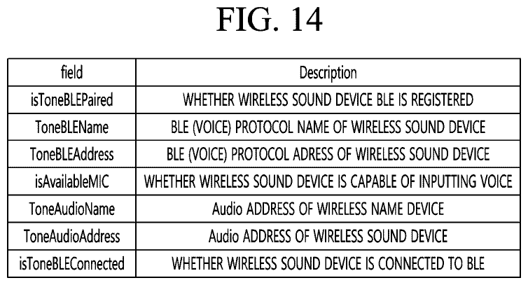

FIG. 14 is a table illustrating device information corresponding to a voice utterance-supported wireless sound device that supports voice utterance.

As illustrated in FIG. 14, device information for a voice utterance-supported wireless sound device may include not only the model name of the voice utterance-supported wireless sound device, but also whether the voice utterance-supported wireless sound device is registered for voice connection communication, a voice connection communication protocol name, a voice connection communication protocol address, whether voice input is possible, an audio name, an audio address, and whether voice communication is connected.

Accordingly, the present disclosure compares first audio address information of a voice utterance-supported wireless sound device that provides a user's voice utterance with second audio address information of a plurality of voice utterance-supported wireless sound device items included in a communication list window, and if a voice utterance-supported wireless sound device item having second audio address information that is identical to the first audio address information exists among the plurality of voice utterance-supported wireless sound device items included in the communication list window, the corresponding voice utterance-supported wireless sound device item can be identified as a voice utterance-supported wireless sound device that provides a user's voice utterance.

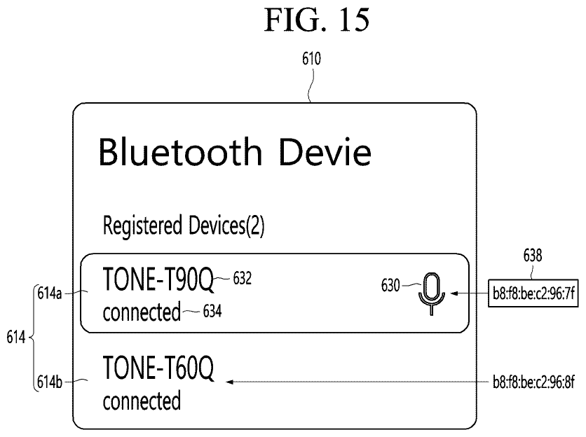

FIG. 15 is a diagram illustrating a communication list window for explaining a process of identifying a voice utterance-supported wireless sound device based on audio address information.

As illustrated in FIG. 15, the present disclosure may provide a communication list window 610 including a first voice utterance-supported wireless sound device item 614a corresponding to a first wireless sound device 510 and a second voice utterance-supported wireless sound device item 614b corresponding to a second wireless sound device 520 when a plurality of wireless sound devices having the same model name are connected for communication.

For example, if the audio address of the first voice utterance-supported wireless sound device item 614a corresponding to the first wireless sound device 510 is b8:f8:be:c2:96:7f and the audio address of the second voice utterance-supported wireless sound device item 614b corresponding to the second wireless sound device 520 is b8:f8:be:c2:96:8f, in the present disclosure, the first voice utterance-supported wireless sound device item 614a may be identified as the first wireless sound device 510 providing the user's voice utterance if the audio address of the voice utterance-supported wireless sound device that provides the user's voice utterance is b8:f8:be:c2:96:7f and if the first voice utterance-supported wireless sound device item 614a having the audio address b8:f8:be:c2:96:7f exists among the plurality of voice utterance-supported wireless sound device items included in the communication list window 610.

In this way, in the present disclosure, a voice utterance-supported wireless sound device that provides a user's voice utterance based on audio address information of the voice utterance-supported wireless sound device can be identified when communicating with a plurality of wireless sound devices having the same model name.

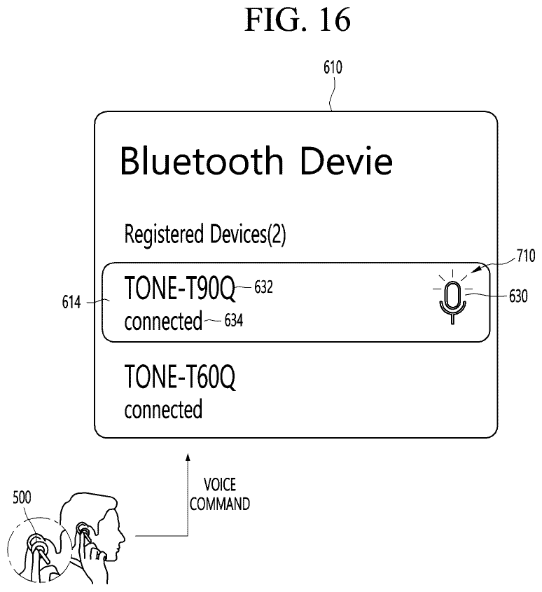

FIG. 16 is a view for explaining a process of displaying utterance activation information of a display device according to one embodiment of the present disclosure.

As illustrated in FIG. 16, the present disclosure can provide utterance activation information 710 indicating that the current utterance is being spoken to a voice utterance-supported wireless sound device item 614 that provides the user's voice utterance among the voice utterance-supported wireless sound device items 614 included in the communication list window 610 when the user's voice utterance is received through a wireless sound device 500 capable of supporting voice utterance.

As an example, in the present disclosure, utterance activation information 710 that provides a blinking effect to a voice recognition activation notification 630 corresponding to a voice utterance-supported wireless sound device item 614 that provides a user's voice utterance, but this is only an example and is not limited thereto.

In addition, the present disclosure can identify a voice utterance-supported wireless sound device item 614 that provides a user's voice utterance based on audio address information of a wireless sound device 500 capable of supporting voice utterance when there are a plurality of voice utterance-supported wireless sound device items 614 included in a communication list window 610, and can provide utterance activation information 710 to the identified voice utterance-supported wireless sound device item 614.

Here, the present disclosure compares first audio address information of a wireless sound device 500 capable of supporting voice utterance providing a user's voice utterance with second audio address information of a plurality of voice utterance-supported wireless sound device items 614 included in a communication list window 610 when identifying a voice utterance-supported wireless sound device items 614, and if there is a voice utterance-supported wireless sound device items 614 among the plurality of voice utterance-supported wireless sound device items 614 included in the communication list window 610 that has second audio address information that is identical to the first audio address information, the corresponding voice utterance-supported wireless sound device items 614 can be identified as a voice utterance-supported wireless sound device 500 that provides a user's voice utterance.

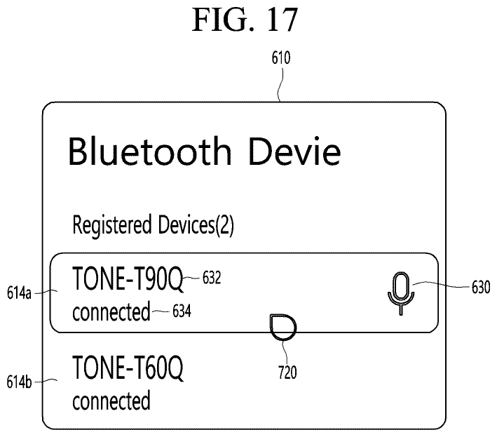

FIG. 17 is a view for explaining a process of displaying an utterance guidance message of a display device according to one embodiment of the present disclosure.

As illustrated in FIG. 17, in the present disclosure, a communication list window 610 may be provided including device information 632 for a voice utterance-supported wireless sound device item, an audio connection notification 634 indicating an audio connection state, and a voice recognition activation notification 630 indicating a voice connection state.

Here, the present disclosure can generate and provide an utterance guidance message 720 for voice utterance input to the selected voice utterance-supported wireless sound device item when a user input for selecting a voice utterance-supported wireless sound device item is received.

For example, in the present disclosure, when a communication list window 610 includes a first voice utterance-supported wireless sound device item 614a and a second voice utterance-supported wireless sound device item 614b, when a user input for selecting the first voice utterance-supported wireless sound device item 614a of the communication list window 610 is received, an utterance guidance message 720 for voice utterance input can be generated and provided for the selected first voice utterance-supported wireless sound device item 614a.

For example, in the present disclosure, an utterance guidance message 720 such as “To use the voice utterance function, touch the right wireless sound device once” may ne provided.

Here, the present disclosure can provide an utterance guidance message 720 by processing it into at least one of text data, voice data, and image data.

In some cases, in the present disclosure, when providing a communication list window 610, if a user input is received for selecting a voice utterance-unsupported wireless sound device item or a wireless sound device that supports voice utterance and cannot use a microphone function, a voice utterance unavailable guidance message for voice utterance input may be generated and provided for the selected wireless sound device item.

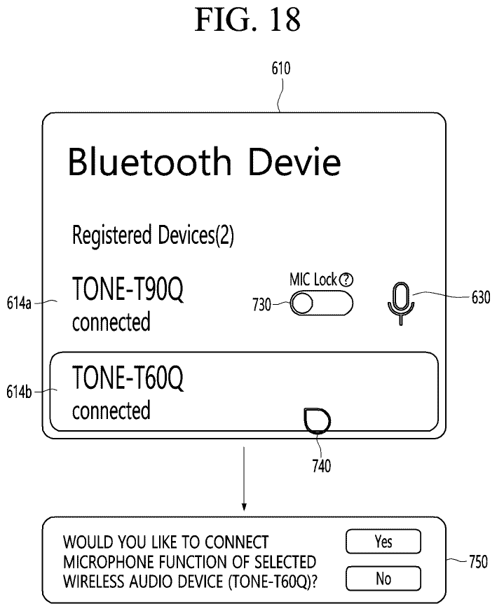

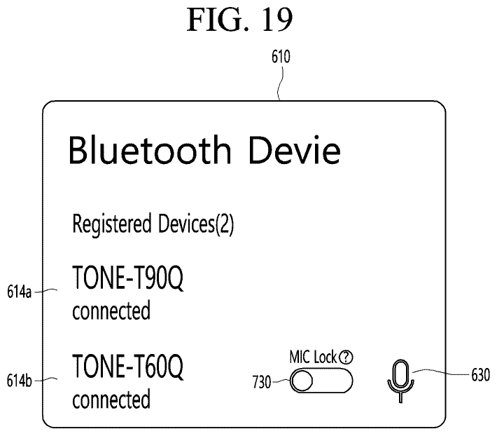

FIG. 18 and FIG. 19 are views for explaining a process of displaying a switching guide message between wireless sound devices of a display device according to one embodiment of the present disclosure.

As illustrated in FIG. 18, in the present disclosure, when providing a communication list window 610, if a user input for selecting a voice utterance-supported wireless sound device item is received, a guidance message for deactivating a microphone function for a previously selected voice utterance-supported wireless sound device item can be generated and provided, and at the same time, a guidance message 740 informing of an utterance unavailable state and a switching method and a message 750 inquiring about whether to activate a microphone function for a currently selected voice utterance-supported wireless sound device item can be generated and provided.

Here, the present disclosure can generate and display a voice recognition activation notification 630 and a microphone function lock menu 730 in a voice utterance-supported wireless sound device item of a communication list window 610.

For example, in the present disclosure, if a communication list window 610 includes a first voice utterance-supported wireless sound device item 614a and a second voice utterance-supported wireless sound device item 614b, when a user input for selecting the second voice utterance-supported wireless sound device item 614b of the communication list window 610 is received, a microphone function deactivation guidance message may be generated and provided for the previously selected first voice utterance-supported wireless sound device item 614a, and at the same time, a guidance message 740 informing of an utterance-unavailable state and a switching method and a microphone function activation inquiry message 750 may be generated and provided for the currently selected second voice utterance-supported wireless sound device item 614b.

For example, in the present disclosure, a microphone function deactivation guidance message, such as “In order to use the microphone function of another wireless sound device, the microphone function of the wireless sound device currently in use is deactivated. If you wish to re-use the microphone function of the wireless sound device currently in use, select the wireless sound device name displayed in the communication connection list menu”, may be generated and the microphone function deactivation guidance message to the first voice utterance-supported wireless sound device item 614a of the communication list window 610 may be provided.

In addition, in the present disclosure, a guidance message 740 that informs of an utterance unavailable state and a switching method, such as “The microphone function of the currently selected wireless sound device cannot be used. If you want to activate the microphone function of the currently selected wireless sound device, select the Yes button in the pop-up menu displayed on the TV screen” may be generated and the guidance message 740 may be provided to the currently selected second voice utterance-supported wireless sound device item 614b.

In addition, in the present disclosure, a microphone function activation inquiry message 750, including a query message asking, “Would you like to connect the microphone function of the selected wireless sound device?”, a Yes button, and a No button, may be generated, and the message may be provided in the form of a pop-up menu on the display screen.

Next, as illustrated in FIG. 19, when the present disclosure receives a user input requesting activation of a microphone function through a microphone function activation inquiry message 750, the voice recognition activation notification of a previously selected voice utterance-supported wireless sound device item may be deleted, and when a communication connection may be performed with a voice utterance-supported wireless sound device corresponding to the currently selected voice utterance-supported wireless sound device item, a voice recognition activation notification 630 may be generated and provided for the currently selected voice utterance-supported wireless sound device item when the voice connection is completed.

For example, in the present disclosure, if a communication list window 610 includes a first voice utterance-supported wireless sound device item 614a and a second voice utterance-supported wireless sound device item 614b, when a user input for selecting the second voice utterance-supported wireless sound device item 614b of the communication list window 610 is received, a voice recognition activation notification of the previously selected first voice utterance-supported wireless sound device item 614a may be deleted, a communication may be performed with a voice utterance-supported wireless sound device corresponding to the currently selected second voice utterance-supported wireless sound device item 614b, and when the voice connection is completed, a voice recognition activation notification 630 may be generated and provided for the second voice utterance-supported wireless sound device item 614b.

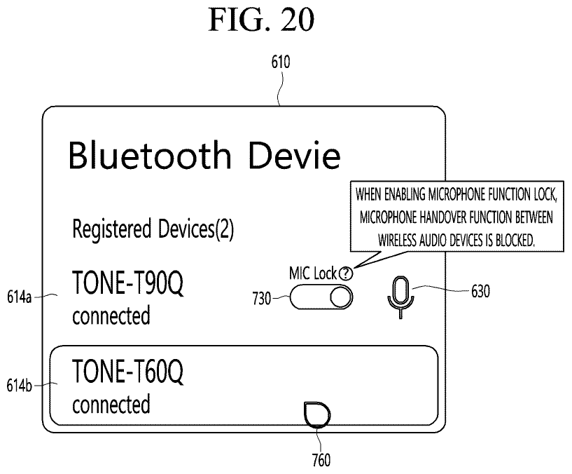

FIG. 20 is a view for explaining a process of displaying a microphone function lock menu of a wireless sound device of a display device according to an embodiment of the present disclosure.

As illustrated in FIG. 20, the present disclosure can generate and display a voice recognition activation notification 630 and a microphone function lock menu 730 in a voice utterance-supported wireless sound device item of a communication list window 610.

Here, the present disclosure can fix the microphone function activation of a corresponding voice utterance-supported wireless sound device item when a user input activating a microphone function lock menu 730 is received, and block the microphone handover function operation between voice utterance-supported wireless sound device items.

For example, the present disclosure checks whether a microphone function lock menu 730 of a previously selected voice-utterance-supported wireless sound device item is activated when a user input for selecting a voice-utterance-supported wireless sound device item is received, and if the microphone function lock menu 730 of the previously selected voice-utterance-supported wireless sound device item is activated, an operation of handing over a microphone function from a previously selected voice utterance-supported wireless sound device item to a currently selected voice utterance-supported wireless sound device item is blocked, thereby maintaining the microphone function of the previously selected voice utterance-supported wireless sound device item activated.

For example, in the present disclosure, if a communication list window 610 includes a first voice-utterance-supported wireless sound device item 614a and a second voice-utterance-supported wireless sound device item 614b, when a user input for selecting the second voice-utterance-supported wireless sound device item 614b of the communication list window 610 is received, it can be checked whether the microphone function lock menu 730 of the previously selected first voice-utterance-supported wireless sound device item 614a is activated, and if the microphone function lock menu 730 of the previously selected first voice-utterance-supported wireless sound device item 614a is activated, an operation of handing over the microphone function from the first voice-utterance-supported wireless sound device item 614a to the currently selected second voice-utterance-supported wireless sound device item 614b is blocked, thereby maintaining the microphone function activation of the first voice-utterance-supported wireless sound device item 614a.

Here, in the present disclosure, a function description message for the microphone function lock menu 730 may be provided when a user input activating the microphone function lock menu 730 is received.

As an example, in the present disclosure, a function description message for a microphone function lock menu 730 that states, “When microphone function lock is activated, microphone handover function between wireless sound devices is blocked.” may be provided.

In addition, in the present disclosure, a microphone handover function blocking guidance message 760 can be generated and provided to a currently selected second voice utterance-supported wireless sound device item 614b.

As an example, in the present disclosure a microphone handover function blocking guidance message 760 that says, “The microphone handover function is blocked, so the microphone function cannot be used. If you want to use the microphone function of the currently selected wireless sound device, unlock the microphone function.” may be provided.

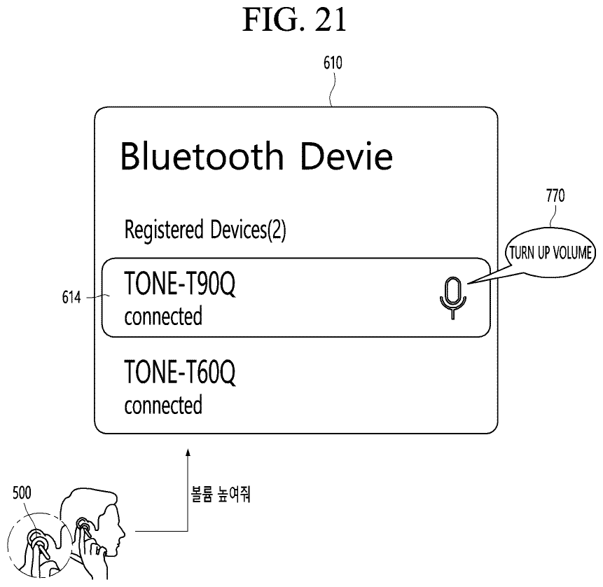

FIG. 21 is a view for explaining a process of displaying voice utterance content of a display device according to one embodiment of the present disclosure.

As illustrated in FIG. 21, in the present disclosure, a communication list window 610 including a voice recognition activation notification may be provided when a voice connection is completed with a wireless sound device 500 capable of supporting voice utterance.

In addition, in the present disclosure, when receiving a user's voice utterance through a wireless sound device 500 capable of supporting voice utterance, the user's voice utterance can be processed into text and the text-processed voice utterance content 770 may be provided to a voice utterance-supported wireless sound device item 614 that provides the user's voice utterance among the voice utterance-supported wireless sound device items included in the communication list window 610.

In some cases, in the present disclosure, a voice utterance-supported wireless sound device item that provides a user's voice utterance based on audio address information of the voice utterance-supported wireless sound device may be identified when there are a plurality of voice utterance-supported wireless sound device items 614 included in a communication list window 610, and text-processed voice utterance content may be provided to the identified voice utterance-supported wireless sound device item.

For example, in the present disclosure, when identifying a voice utterance-supported wireless sound device item 614, first audio address information of a voice utterance-supported wireless sound device that provides a user's voice utterance may be compared with second audio address information of a plurality of voice utterance-supported wireless sound device items included in a communication list window 610, and if there is a voice utterance-supported wireless sound device item having second audio address information that is identical to the first audio address information among the plurality of voice utterance-supported wireless sound device items included in the communication list window 610, the corresponding voice utterance-supported wireless sound device item may be identified as a voice utterance-supported wireless sound device that provides a user's voice utterance.

In another case, in the present disclosure when a communication list window 610 is provided, if receiving a user's voice utterance through a voice utterance-supported wireless sound device, a voice utterance-supported wireless sound device item that provides voice utterance to the user based on the audio address information of the a voice utterance-supported wireless sound device may be identified, and a communication connection list window 610 may be provided so that the identified voice utterance-supported wireless sound device item is arranged with the highest priority in the communication list.

In other words, in the present disclosure, the visibility of a wireless sound device that is uttering can be improved so that a user can easily recognize it by providing a communication list window 610 so that a voice utterance-supported wireless sound device item corresponding to a currently uttering wireless sound device is arranged with the highest priority in the communication list.

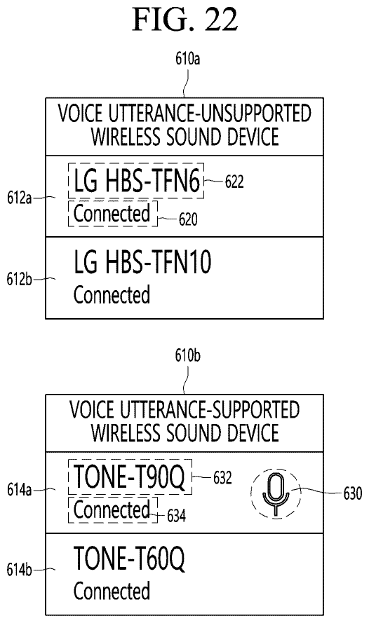

FIG. 22 is a view for explaining a process of displaying a communication list window for a voice utterance-unsupported wireless sound device and a wireless sound device that supports voice utterance in a display device according to an embodiment of the present disclosure.

As illustrated in FIG. 22, in the present disclosure, based on the determination result of whether the wireless sound device supports voice utterance, the voice utterance-unsupported wireless sound device and the voice utterance-supported wireless sound device may be distinguished among a plurality of communicating wireless sound devices, a first communication list window 610a including a voice utterance-unsupported wireless sound device and a second communication list window 610b including a voice utterance-supported wireless sound device may be provided, and a voice recognition activation notification 630 may be displayed through the second communication list window 610b.

Here, the first communication list window 610a may include device information 622 for a plurality of voice utterance-unsupported wireless sound device items including a first voice utterance-unsupported wireless sound device item 612a and a second voice utterance-unsupported wireless sound device item 612b, and an audio connection notification 620 that informs of an audio connection state.

For example, device information 622 for a voice utterance-unsupported wireless sound device item may include the model name of the voice utterance-unsupported wireless sound device.

Additionally, device information 622 for a voice utterance-unsupported wireless sound device item may further include an audio name and audio address of the voice utterance-unsupported wireless sound device.

In addition, the audio connection notification 620 may include an audio connection message that notifies an audio connection state, or an audio disconnection message that notifies an audio disconnection state including an audio connection release or an audio connection failure.

Next, the second communication list window 610b may include device information 632 for a plurality of voice utterance-supported wireless sound device items including a first voice utterance-supported wireless sound device item 614a and a second voice utterance-supported wireless sound device item 614b, an audio connection notification 634 that notifies an audio connection state, and a voice recognition activation notification 630 that notifies a voice connection state.

For example, device information 632 for a voice utterance-supported wireless sound device item may include the model name of the voice utterance-supported wireless sound device.

In addition, device information 632 for a voice utterance-supported wireless sound device item may further include whether the voice utterance-supported wireless sound device is registered for voice connection communication, a voice connection communication protocol name, a voice connection communication protocol address, whether voice input is possible, an audio name, an audio address, and whether voice communication is connected.

In addition, the audio connection notification 620 may include an audio connection message that notifies an audio connection state, or an audio disconnection message that notifies an audio disconnection state including an audio connection release or an audio connection failure.

Next, the voice recognition activation notification 630 may include a voice connection icon that indicates a voice connection state, or a voice disconnection icon that indicates a voice disconnection state including a voice connection release or voice connection failure.

In other words, in the present disclosure, a first communication list window 610a including a voice utterance-unsupported wireless sound device and a second communication list window 610b including a voice utterance-supported wireless sound device may be distinguished and provided, thereby allowing a user to easily identify a voice utterance-unsupported wireless sound device and a voice utterance-supported wireless sound device.

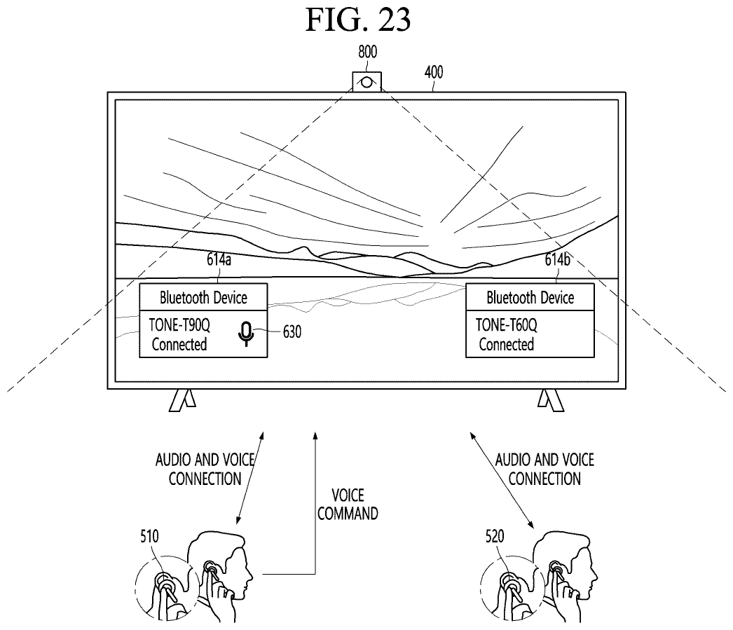

FIG. 23 is a view for explaining a process of displaying a voice recognition activation notification corresponding to the position coordinates of a wireless sound device of a display device according to an embodiment of the present disclosure.

As illustrated in FIG. 23, the display device 400 of the present disclosure may include a camera 800 that photographs a plurality of wireless sound devices.

Here, in the present disclosure, when generating a voice recognition activation notification 630, a camera 800 may be activated to obtain an image from the camera 800, the position coordinates of a wireless sound device based on the obtained image, and when the voice recognition activation notification 630 is generated, the voice recognition activation notification 630 can be displayed on a specific area of the display screen corresponding to the position coordinates of the wireless sound device that is currently voice-connected.

For example, in the present disclosure, when a plurality of wireless sound devices including a first wireless sound device 510 and a second wireless sound device 520 are communicated, if both the first wireless sound device 510 and the second wireless sound device 520 are determined to be wireless sound devices capable of supporting voice utterance, a communication list window including a first voice utterance-supported wireless sound device item 614a and a second voice utterance-supported wireless sound device item 614b may be provided.

Here, in the present disclosure, the position coordinates of the first wireless sound device 510 may be calculated based on an image obtained from a camera 800, and if the first wireless sound device 510 is located on the left side of the display device 400 based on the position coordinates of the first wireless sound device 510, a communication list window including a first voice utterance-supported wireless sound device item 614a may be provided in a left area of the display screen, and if a voice connection is currently being made to the first wireless sound device 510, a voice recognition activation notification 630 may be provided in the communication list window including the first voice-activated wireless sound device item 614a.

In addition, in the present disclosure, the position coordinates of the second wireless sound device 520 may be calculated based on an image obtained from a camera 800, and, based on the position coordinates of the second wireless sound device 520, if the second wireless sound device 520 is located on the right side of the display device 400, a communication list window including a second voice utterance-supported wireless sound device item 614b may be provided in the right area of the display screen.

In addition, the present disclosure can receive a user's voice utterance from the first wireless sound device 510 and perform a control command corresponding to the user's voice utterance when a voice recognition activation notification 630 is displayed in a communication list window including a first voice utterance-supported wireless sound device item 614a.

In some cases, in the present disclosure, when performing a voice control command, if a first control command of a voice utterance received from a first voice utterance-supported wireless sound device among a plurality of wireless sound devices and a second control command of a voice utterance received from a second voice utterance-supported wireless sound device conflict with each other, the control command of the voice utterance received from the voice utterance-supported wireless sound device having a higher priority may be performed based on preset priority information, and the control command of the voice utterance received from the voice utterance-supported wireless sound device having a relatively lower priority may be ignored.

For example, in the present disclosure, if a first voice control command of a user received from a first wireless sound device 510 is “TV ON” and a second voice control command of the user received from a second wireless sound device 520 is “TV OFF”, since the first voice control command received from the first wireless sound device 510 and the second voice control command received from the second wireless sound device 520 conflict with each other, the first voice control command received from the first wireless sound device 510 with a higher priority is performed based on preset priority information, and the second voice control command received from the second wireless sound device 520 with a relatively lower priority is ignored, thereby performing the first voice control command of the user, which is “TV ON”.

In another case, the present disclosure may obtain control command information for each voice utterance-supported wireless sound device when performing a voice control command, and provide user-specific recommendation information based on the control command information for each voice utterance-supported wireless sound device.

For example, in the present disclosure, if the frequency of control commands preferring sports channels is greater than a preset value as a result of analyzing control command information of the first wireless sound device 510, when voice connection is established with the first wireless sound device 510, recommendation information recommending sports-related programs or sports-related products can be provided.

As another example, in the present disclosure, after control command information of a second wireless sound device 520 is analyzed, if the frequency of a control command preferring a movie channel is equal to or greater than a preset value, recommendation information recommending a movie-related program or movie-related products can be provided when a voice connection is established with the second wireless sound device 520.

As another case, in the present disclosure, control command information for each voice utterance-supported wireless sound device can be obtained when performing a voice control command, and a display screen configuration for each user can be predicted and provided based on the control command information for each voice utterance-supported wireless sound device.

For example, in the present disclosure, if control command information of a first wireless sound device 520 is analyzed and then the frequency of a control command preferring TV volume at a specific level is equal to or greater than a preset value, the display screen configuration can be predicted and provided to output a specific level of TV volume when a voice connection is established with the first wireless sound device (510).

As another example, in the present disclosure, after analyzing the control command information of the second wireless sound device 520, if the frequency of the control command preferring a specific level of screen brightness is equal to or greater than the preset value, the display screen configuration can be predicted and provided to set the screen brightness to a specific level when a voice connection is established with the second wireless sound device 520.

In this way, in the present disclosure, whether each wireless sound device supports voice utterance may be determined based on the communication state of the wireless sound device, and a voice recognition activation notification for a wireless sound device capable of supporting voice utterance, thereby improving user convenience so that the user can intuitively and easily identify a voice utterance-supported wireless sound device.

In addition, in the present disclosure, by providing utterance activation information indicating that current utterance is being spoken together with a voice recognition activation notification for wireless sound devices capable of supporting voice utterance, thereby allowing a user to intuitively recognize a wireless sound device that is uttering.

In addition, in the present disclosure, by providing utterance guidance message for voice utterance input together with voice recognition activation notifications for wireless sound devices capable of supporting voice utterance, thereby allowing a user to easily recognize a voice utterance input method.

In addition, in present disclosure, by providing a microphone function lock menu together with a voice recognition activation notification for wireless sound devices capable of supporting voice utterance, thereby providing user convenience by blocking microphone handover function operation between voice utterance-supported wireless sound devices.

The above-described present disclosure can be implemented as a computer-readable code on a medium in which a program is recorded. The computer-readable medium includes all kinds of recording devices in which data that can be read by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. In addition, the computer may include a processor 180 of an artificial intelligence device.

### INDUSTRIAL APPLICABILITY

The display device according to the present disclosure has remarkable industrial applicability because it provides a voice recognition activation notification for a wireless sound device capable of supporting voice utterance, thereby improving user convenience by allowing the user to intuitively and easily identify the voice utterance-supported wireless sound device.

1. A display device comprising:
a communication part communicating with a plurality of wireless sound devices;
a display part displaying a voice recognition activation notification of the wireless sound devices; and,
a processor controlling the communication part and the display part,
wherein the processor performs a communication with the plurality of wireless sound devices, determines whether each wireless sound device supports voice utterance based on the communication state of the wireless sound devices, and generates a voice recognition activation notification for a wireless sound device capable of supporting voice utterance to display the voice recognition activation notification on the display part.

2. The display device of claim 1,
wherein the processor, when performing a communication with the plurality of wireless sound devices, performs an audio connection with the wireless sound device through the first communication, and performs a voice connection with the wireless sound device through the second communication.

3. The display device of claim 2,
wherein the processor performs an audio connection with the wireless sound device through Bluetooth communication and performs a voice connection with the wireless sound device through BLE (Bluetooth Low Energy) communication.

4. The display device of claim 1,
wherein the processor,
when determining whether the wireless sound device supports voice utterance, if the communicating wireless sound device has completed only the audio connection through the first communication, determines the wireless sound device as a voice utterance-unsupported wireless sound device, and
if the communicating wireless sound device has completed both the audio connection through the first communication and the voice connection through the second communication, determines the wireless sound device as a voice utterance-supported wireless sound device.

5. The display device of claim 1,
wherein the processor,
when generating the voice recognition activation notification, distinguishes between a voice utterance-unsupported wireless sound device and a voice utterance-supported wireless sound device among a plurality of wireless sound devices that communicates with each other based on a determination result of determining whether the wireless sound device supports voice utterance, and provides a communication list window including voice utterance-unsupported wireless sound device items and voice utterance-supported wireless sound device items, and displays the voice recognition activation notification through the communication list window.

6. The display device of claim 5,
wherein the processor, if receiving a user's voice utterance through the voice utterance-supported wireless sound device, provides utterance activation information indicating that the current utterance is being spoken to a voice utterance-supported wireless sound device item that provides the user's voice utterance among the voice utterance-supported wireless sound device items included in the communication list window.

7. The display device of claim 5,
wherein the processor,
when providing the communication list window, if a user input for selecting the voice utterance-supported wireless sound device item is received, generates and provides an utterance guidance message for voice utterance input to the selected voice utterance-supported wireless sound device item.

8. The display device of claim 5,
wherein the processor,
when providing the communication list window, when a user input for selecting the voice utterance-unsupported wireless sound device item is received, generates and provides an utterance unavailable guidance message for voice utterance input to the selected voice utterance-unsupported wireless sound device item.

9. The display device of claim 5,
wherein the processor,
when providing the communication list window, if a user input for selecting the voice utterance-unsupported wireless sound device item is received, generates and provides a microphone function deactivation guidance message to the previously selected voice utterance-supported wireless sound device item, and at the same time generates and provides an utterance unavailable guidance message for voice utterance input for the currently selected voice utterance-unsupported wireless sound device item.

10. The display device of claim 5,
wherein the processor,
when providing the communication list window, if a user input for selecting the voice utterance-supported wireless sound device item is received, generates and provides microphone function deactivation guidance message to previously selected voice utterance-supported wireless sound device and at the same time, generates and provides a guidance message informing an utterance unavailable state and a a switching method it and message inquiring whether to enable microphone function to be activated to currently selected voice utterance-supported wireless sound device item.

11. The display device of claim 10,
wherein the processor,
when receiving a user input requesting microphone function activation through the microphone function activation inquiry message, deletes the voice recognition activation notification of the previously selected voice utterance-supported wireless sound device item, performs a communication with the voice utterance-supported wireless sound device corresponding to the currently selected voice utterance-supported wireless sound device item, and when the voice connection is completed, generates and provides the voice recognition activation notification for the currently selected voice utterance-supported wireless sound device item.

12. The display device of claim 5,
wherein the processor,
when displaying the voice recognition activation notification through the communication list window, generates and displays a voice recognition activation notification and a microphone function lock menu in the voice utterance-supported wireless sound device item of the communication list window.

13. The display device of claim 5,
wherein the processor, when receiving a user's voice utterance through the voice utterance-supported wireless sound device, processes the user's voice utterance into text, and provides the text-processed voice utterance content to a voice utterance-supported wireless sound device item that provides the user's voice utterance among the voice utterance-supported wireless sound device items included in the communication list window.

14. The display device of claim 1,
wherein the processor,
when a voice recognition activation notification for the wireless sound device capable of supporting voice utterance is displayed, receives a user's voice utterance from the wireless sound device capable of supporting voice utterance, and performs a control command corresponding to the user's voice utterance.

15. A method for operating a display device that communicates with a plurality of wireless sound devices, comprising:
performing a communication with the plurality of wireless sound devices;
determining whether each wireless sound device supports voice utterance based on a communication state of the wireless sound devices;
generating a voice recognition activation notification for the wireless sound device capable of supporting voice utterance; and
outputting a voice recognition activation notification for the wireless sound device capable of supporting voice utterance.
